(19) United States
(12) Patent Application Publication
(10) Pub. No.: US 2011/0190966 A1
(43) Pub. Date: Aug. 4, 2011

(54) Control System For An Aircraft Propeller Drive

(75) Inventors: Eric Bollen, Hamburg (DE); Bodo Metzdorf, Hamburg (DE)

(73) Assignee: THEILERT AIRCRAFT ENGINES GMBH, Lichtenstein (DE)

(21) Appl. No.: 13/062,842

(22) PCT Filed: Aug. 25, 2009
(86) PCT No.: PCT/EP2009/060953

§ 371 Date: Apr. 20, 2011

(30) Foreign Application Priority Data
Sep. 9, 2008 (DE) 10 2008 041 925.7

(51) Int. Cl. G06F 19/00

(52) U.S. Cl. 701/3

(57) ABSTRACT

The invention relates to a control system for an aircraft propeller drive for controlling the power of a diesel engine (2) by means of an accelerator (7) and a control module (8), and for controlling the speed of the aircraft propeller (4) which can be controlled by a propeller blade control valve (6) and which is connected to the diesel engine (2) by means of a drive train (3). The control module comprises a totally digital power unit regulator (8) integrating a closed control circuit which is connected to the accelerator for controlling the power and to the propeller blade control valve for controlling the speed of the propeller. The control circuit compares the desired value based on the position of the accelerator and the measured actual value of the engine speed and controls the propeller blade control valve (6) based on the determined differential speed, and automatically adapts the propeller speed to the engine power predetermined by the position of the accelerator. The control system has one lever reducing the burden on the pilot and a reduced number of components.

### TECHNICAL FIELD

The invention relates to a control system for an aircraft propeller drive for controlling the power of the engine and controlling the speed of the propeller connected to the latter by means of a drive train.

### BACKGROUND

The known aircraft propeller drives usually consist of a drive engine, for example a gasoline engine, and a propeller connected to the drive engine by means of a safety coupling and gearing. The engine power is controlled as a function of the desired power input by the pilot by means of a first actuating lever (accelerator) and the measured actual power by means of a redundantly designed engine control system. By adjusting the angular position of the propeller blades with the help of a second actuating lever as a function of the respective engine power, the propeller speed is readjusted based on the respective engine power via a propeller control system that had previously not had a redundant design by comparing the desired speed value input with the second actuating lever with a measured actual value for the propeller speed. This type of control with two actuating levers and two control systems presents the pilot with a significant burden, and is also unreliable in light of potential operator errors in setting the propeller speed or lacking redundancy of the respective control system, while also requiring a significant number of components.

The object of the invention is to provide a redundant control system for controlling the power of the motor and controlling the speed of the propeller in an aircraft propeller drive, which is characterized by a high reliability and diminished burden on the pilot, along with a reduced number of components.

The object is achieved with a control system according to the features of the invention.

The basic idea of the invention has to do with effecting a shared, single-lever control of both the motor power as established by the accelerator and the speed of the aircraft propeller, by virtue of the fact that a power unit regulator (FADEC) used for engine control both receives input signals from the engine as well as actuating lever for adjusting the engine power (accelerator), and relays output signals for engine control to the motor as well as output signals computed based on the ascertained desired speed and measured actual speed to the propeller blade control valve. Therefore, the controller according to the invention for an aircraft propeller drive for controlling the power of the diesel engine by means of an accelerator and a control module, and for controlling the speed of the aircraft propeller, which is connected with the diesel engine by means of a drive train and can be controlled via a propeller blade control valve, encompasses a totally digital power unit regulator that integrates a closed control circuit connected to the accelerator for controlling the power and to the propeller blade control valve for controlling the speed of the propeller, which compares the desired value based on the position of the accelerator and the measured actual value of the engine speed, and controls the propeller blade control valve based on the determined differential speed, and automatically adapts the propeller speed to the engine power predetermined by the position of the accelerator. The single-lever operation realized by the invention unburdens the pilot, and reduces the number of components for the controller, which also has a redundant design.

The control circuit encompasses an evaluator unit supplied by the accelerator for determining the desired value for speed, a control unit for checking the ascertained desired value, a comparator for comparing the desired value with the actual value measured on the diesel engine and calculating the difference, as well as a PID controller for setting the propeller blade control valve and adjust the propeller speed to the predetermined engine power.

### BRIEF DESCRIPTION OF THE DRAWINGS

An exemplary embodiment of the invention will be explained in greater detail based on the drawing, in which

FIG. 1 shows an aircraft propeller drive with a totally digital power unit regulator (FADEC) with integrated propeller speed controller for controlling the power of the motor; and

FIG. 2 shows a block diagram of the propeller controller.

### DETAILED DESCRIPTION OF THE INVENTION

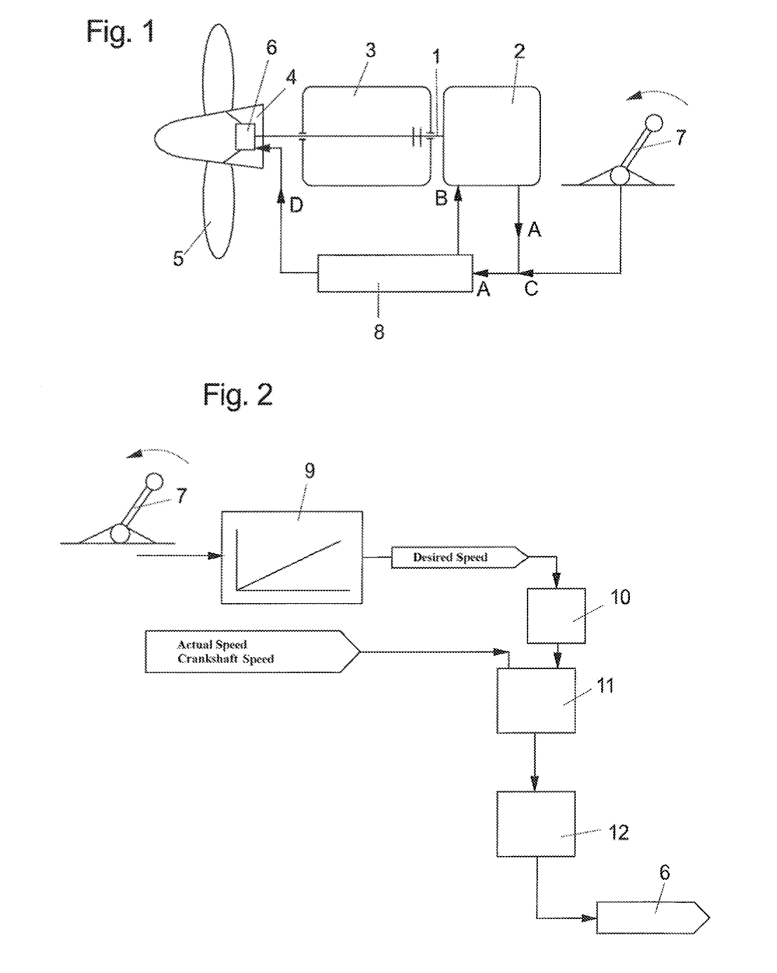

As shown on FIG. 1, the crankshaft 1 of a diesel engine 2 is connected by means of a drive train 3 to an aircraft propeller 4, the propeller blades 5 of which can be adjusted via a propeller blade control valve 6 for controlling the speed of the propeller. The pilot sets the desired speed of the propeller by means of an accelerator 7. For purposes of engine and propeller control, the accelerator 7, diesel engine 2 plus drive train 3, and propeller blade control valve 6 are connected to a digital power unit regulator 8 known as FADEC. The totally digital power unit regulator 8 receives input signals (sensor signals) per arrow A, and relays corresponding output signals (engine control signals) to the diesel engine 2 per arrow B for controlling the engine by way of fuel injection, pressure, boost pressure and glowing. In addition, the digital power unit regulator 8 receives an input signal per arrow C from the accelerator 7 actuated by the pilot or the accelerator position. An evaluator unit 9 makes use of the closed control circuit integrated into the power unit regulator 8 and depicted in simplified form on FIG. 2 to first determine the desired value for speed corresponding to the accelerator position, and check it in a control unit 10. In a comparator 11, the desired value for speed is compared with the actual value for speed relayed by the crankshaft speed sensor to the power unit regulator 8. Based on the ascertained difference between the actual and desired value for speed, the subsequent PID controller 12 controls the propeller blade control valve 6 (output signal per arrow D on FIG. 1) in such a way that the speed of the aircraft propeller 4 is automatically adjusted to the power of the diesel engine 2 predetermined by the pilot with the accelerator 7 through the automatic adjustment of the propeller blades.

The process of regulating the propeller speed via the accelerator 7 provided for controlling the engine power integrated into the power unit regulator provided for engine control eliminates the second actuating lever required in prior art for propeller control, along with the corresponding, non-redundant control module, thereby on the one hand diminishing the burden on the pilot, who now only has to operate one actuating lever. In addition, the totally digital power unit regulator (FADEC) 8 provides a redundant control system. Further, the number of components can be reduced by comparison with the known two-lever controller.

### REFERENCE LIST

1 Crankshaft
2 Diesel engine
3 Drive train
4 Aircraft propeller
5 Propeller blades
6 Propeller blade control valve
7 Accelerator
8 Power unit regulator (FADEC)
9 Evaluator unit
10 Control unit
11 Comparator
12 PID controller
Arrow A Input signals, sensor signals
Arrow B Output signals, engine controller signals
Arrow C Input signals, accelerator signal
Arrow D Output signals, propeller controller signal

1. A control system for an aircraft propeller drive for controlling the power of a diesel engine (2) comprising:
an accelerator (7) and a control module (8), the control system controlling a speed of an aircraft propeller, connected to the diesel engine (2) by a drive train (3), the control system having a propeller blade control valve (6) for controlling the aircraft propeller speed, wherein the control module is a totally digital power unit regulator (8) that integrates a closed control circuit connected to the accelerator (7) and to the propeller blade control valve (6), which compares a desired value based on an accelerator position and a measured actual value of engine speed, the control system controlling the propeller blade control valve (6) based on an ascertained differential speed, and automatically adjusts the speed of the propeller in relation to the engine power predetermined via the position of the accelerator (7).

2. The control system of claim 1, wherein the closed control circuit consists of an evaluator unit (9) supplied by an output signal of the accelerator for ascertaining the desired value for speed, a control unit (10) for checking the ascertained desired value, a comparator (11) for comparing the desired value with the actual value measured on the diesel engine (2) and for determining a difference existing between the actual value and the desired value, and, a PID controller (12) for setting the propeller blade control valve and adjusting the propeller speed to the predetermined engine power.
